(19) United States
(12) Patent Application Publication
(10) Pub. No.: US 2024/0378003 A1
(43) Pub. Date: Nov. 14, 2024

(54) NON-TRANSITORY RECORDING MEDIUM STORING COMPUTER-READABLE MONITORING PROGRAM, AND PRINTING SYSTEM

(71) Applicant: Konica Minolta, Inc., Tokyo (JP)

(72) Inventor: Seiji SHIBATA, Tokyo (JP)

(73) Assignee: Konica Minolta, Inc., Tokyo (JP)

(21) Appl. No.: 18/658,289

(22) Filed: May 8, 2024

(30) Foreign Application Priority Data
May 11, 2023 (JP) 2023-078398

(51) Int. Cl. G06F 3/12; H04N 1/00

(52) U.S. Cl. CPC G06F 3/1263; G06F 3/1273; G06F 3/1286; H04N 1/00408

(57) ABSTRACT

A non-transitory recording medium storing a computer-readable monitoring program presents information regarding a related task for handling a problem of a printing machine in the most efficient order, thus improving work efficiency in handling the problem. The non-transitory recording medium storing the computer-readable monitoring program causes a computer to execute acquiring state information regarding a state of a printing machine, extracting related task information associated with the acquired state information from registered related task information corresponding to the state information, and calculating, in a case where a plurality of pieces of the extracted related task information are present, a priority order in which the pieces of related task information are to be displayed.

### CROSS-REFERENCE TO RELATED APPLICATION

The entire disclosure of Japanese patent Application No. 2023-078398, filed on May 11, 2023, is incorporated herein by reference in its entirety.

### BACKGROUND OF THE INVENTION

### 1. Technical Field

The present invention relates to a non-transitory recording medium storing a computer-readable monitoring program, and a printing system.

### 2. Description of Related Art

Conventionally, in the industrial printing industry, when a problem occurs in a printing machine, in general, a printing company notifies a printing machine manufacturer of the problem, and a service engineer of the printing machine manufacturer goes to the printing company (site) to solve the problem in the printing machine. However, when a problem occurs in the printing machine outside business hours of a service counter of the printing machine manufacturer, that is, when the printing machine manufacturer cannot immediately respond to the problem, an operator of the printing company has no choice but to handle the problem. However, the operator of the printing company may not know a procedure of a recovery task for handling the problem, and thus the recovery task may be difficult. Therefore, a technique of displaying a moving image indicating maintenance of the printing machine, that is, a moving image indicating the content of a related task on a display panel of the printing machine has been proposed. This technique is described in Japanese Unexamined Patent Publication No. 2009-096069.

Japanese Unexamined Patent Publication No. 2009-096069 describes a printing apparatus including print processing means, notification means, reception means that receives moving image data supplied from a host apparatus based on a notification, and display means. The print processing means performs print processing on a recording medium based on print data. The notification means notifies the host apparatus of state information of the printing apparatus. The reception means receives the moving image data indicating an operation procedure of the printing apparatus for the state of the printing apparatus. The display means displays the moving image data.

### SUMMARY OF THE INVENTION

As described above, in order to enable the operator of the printing company to perform the recovery task for handling the problem of the printing machine, Japanese Unexamined Patent Publication No. 2009-096069 proposes a technique in which a moving image indicating the operation procedure is displayed on the display means of the printing apparatus. As a notification for handling the problem, an error code is generally notified. However, there may be a case where problem handling procedures to be carried out cannot be narrowed down to one procedure using only an error code. For example, in a process in which a single sheet is conveyed from a sheet feed cassette of the printing machine to a secondary transfer roller, in a case where the sheet cannot be detected immediately before a secondary transfer step is started, an error code assigned to a problem caused by no sheet is generated. However, the error code may be generated due to any of two causes: a jam of the sheet in a conveyance process; and a failure to convey the sheet in the conveyance process due to a slip of a sheet roller that takes the sheet out of a sheet storage. Procedures of recovery tasks for eliminating the two causes are different.

However, the technique described in Japanese Unexamined Patent Publication No. 2009-096069 does not describe a method of outputting an appropriate procedure of a recovery task when a plurality of procedures of the recovery task are extracted based on a notification for handling the problem.

The present invention has been made in view of the above-described circumstances, and an object of the present invention is to present information regarding a related task for handling a problem of a printing machine in the most efficient order, thereby improving work efficiency in handling the problem.

In the present invention, processing of acquiring state information regarding a state of a printing machine, processing of extracting related task information associated with the acquired state information from registered related task information corresponding to the state information, and processing of calculating, in a case where a plurality of pieces of the extracted related task information are present, a priority order in which the pieces of related task information are to be displayed are performed.

### BRIEF DESCRIPTION OF THE DRAWINGS

The advantages and features provided by one or more embodiments of the invention will become more fully understand from the detailed description given hereinbelow and the appended drawings which are given by way of illustration only, and thus are not intended as a definition of the limits of the present invention.

FIG. 1 is a diagram illustrating an example of a schematic configuration of a printing system according to a first embodiment of the present invention;

FIG. 2 is a diagram illustrating an example of data of execution histories of related tasks in the printing system according to the first embodiment of the present invention;

FIG. 3 is a diagram illustrating the priority order of the related tasks calculated by a first calculation method in the printing system according to the first embodiment of the present invention;

FIG. 4 is a diagram for explaining a second calculation method of calculating the priority order of related tasks in the printing system according to the first embodiment of the present invention;

FIG. 5A and FIG. 5B are diagrams for explaining a first specific example of the second calculation method of calculating the priority order of related tasks in the printing system according to the first embodiment of the present invention;

FIG. 6A and FIG. 6B are diagrams for explaining a second specific example of the second calculation method of calculating the priority order of related tasks in the printing system according to the first embodiment of the present invention;

FIG. 7 is a flowchart illustrating a procedure of a monitoring process in the printing system according to the first embodiment of the present invention;

FIG. 8 is a block diagram illustrating an example of a hardware configuration of a monitoring apparatus of the printing system according to the first embodiment of the present invention; and

FIG. 9 is a flowchart illustrating a procedure of a monitoring process in a printing system according to a second embodiment of the present invention.

### DETAILED DESCRIPTION

Hereinafter, one or more embodiments of the present invention will be described with reference to the drawings. However, the scope of the invention is not limited to the disclosed embodiments.

In the present specification and drawings, constituent elements having substantially the same functions or configurations are denoted by the same reference numerals, and redundant description is omitted.

### First Embodiment

### Example of Schematic Configuration of Printing System

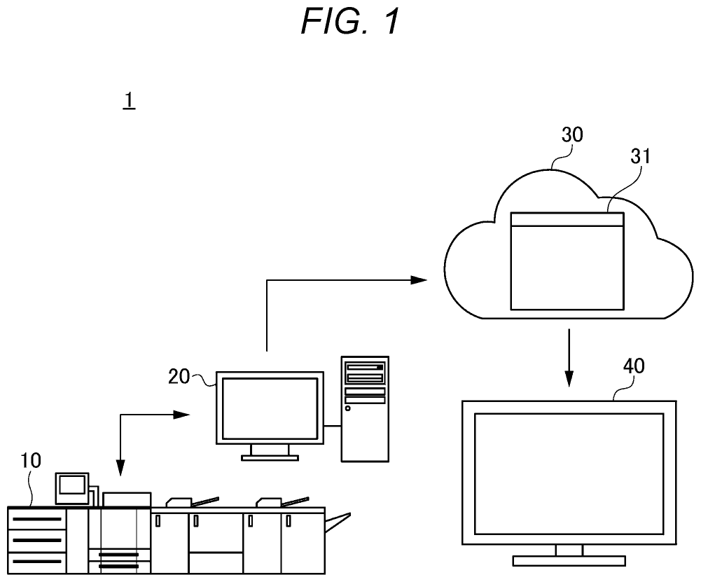

First, a schematic configuration of a printing system 1 according to a first embodiment of the present invention will be described. FIG. 1 is a diagram illustrating an example of the schematic configuration of the printing system according to the first embodiment of the present invention. As illustrated in FIG. 1, the printing system 1 includes a printing machine 10, a management terminal 20, a server 30, and a monitoring apparatus 40.

The printing machine 10 is an example of an image forming apparatus that forms an image on a recording medium by an electrophotographic method. The printing machine 10 is, for example, a multi-function peripheral (MFP) having a plurality of functions such as a scanner function, a copy function, a facsimile function, a network function, a box function, and a post-processing function. When a problem (abnormality) occurs in the printing machine 10, the printing machine 10 outputs state information regarding a state of the printing machine 10 to the management terminal 20. Although FIG. 1 illustrates only the one printing machine, the present invention is not limited thereto, and the printing system 1 may include a plurality of printing machines.

In this case, the state of the printing machine 10 is a state in which printing is stopped in a normal operation of the printing machine and a predetermined task is required to resume the printing. States of the printing machine 10 include an abnormal state in which the printing machine becomes a failure state and an error code is output, and an abnormal state other than the failure state in which the error code is output. For example, a failure state in which a component of the printing machine does not operate is an abnormal state in which an error code is generated. In addition, for example, in abnormal states such as out of recording medium (paper), out of toner, a waste toner bottle full of waste toner, and a sheet ejection tray full of sheets, an error code is not generated.

These states of the printing machine 10 are cleared by tasks such as replenishment of a recording medium (paper), replenishment of toner, replacement of a waste toner bottle, and collection of a printed product on a sheet ejection tray by an operator. Furthermore, for example, printing malfunction caused by stains attached to the printing machine and detected by a printed product inspector or the like, another abnormality causing interruption of printing, and the like may be included in the abnormal states in which an error code is not generated. In addition, the state information regarding the state of the printing machine 10 includes a message for notifying an abnormal state in which an error code is not generated and an error code for an abnormal state in which the error code is generated. Even in a case where the printing machine does not become abnormal, for example, information indicating almost out of recording medium (sheet), almost out of toner, a waste toner bottle almost full, the sheet ejection tray almost full, a printed product becoming dirtier, and the like may be output as the state information.

The management terminal 20 is an example of an information processing apparatus and is connected to the printing machine 10 in a wired or wireless manner. For example, the management terminal 20 corrects image data before printing, designates the size of a print image and a color mode or a monochrome mode, and outputs a print instruction to the printing machine 10. In addition, when a problem occurs in the printing machine 10, the management terminal 20 receives state information regarding the state of the printing machine 10 from the printing machine 10 and transmits the received state information to the server 30 via a network.

The server 30 is, for example, a cloud server. The server 30 executes a monitoring program 31 that acquires various information regarding the printing machine 10 from the management terminal 20 and performs various analyses using the acquired information.

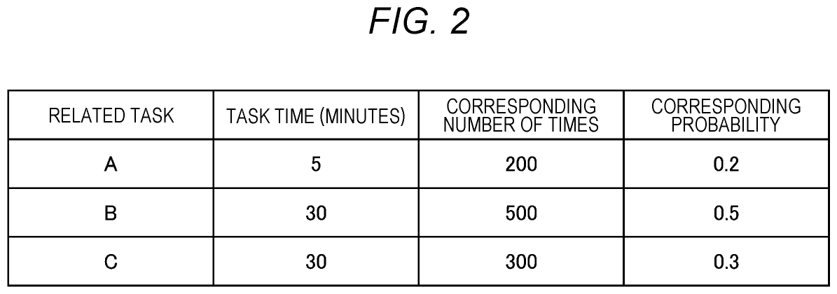

In addition, the server 30 stores an execution history (see FIG. 2 which will be described later) of a recovery task (related task) which can solve a problem and related task information (hereinafter, referred to as “related task information”) registered in advance, which correspond to the state information regarding the state of the printing machine 10. Here, the related task information is information indicating the content (e.g., a moving image, an audio description, a procedure manual, or the like) of the related task or information of access to a storage destination of the content of the related task. The information of access to the storage destination is, for example, an address for access to the storage destination, a read code that enables reading of the address for access to the storage destination, or the like.

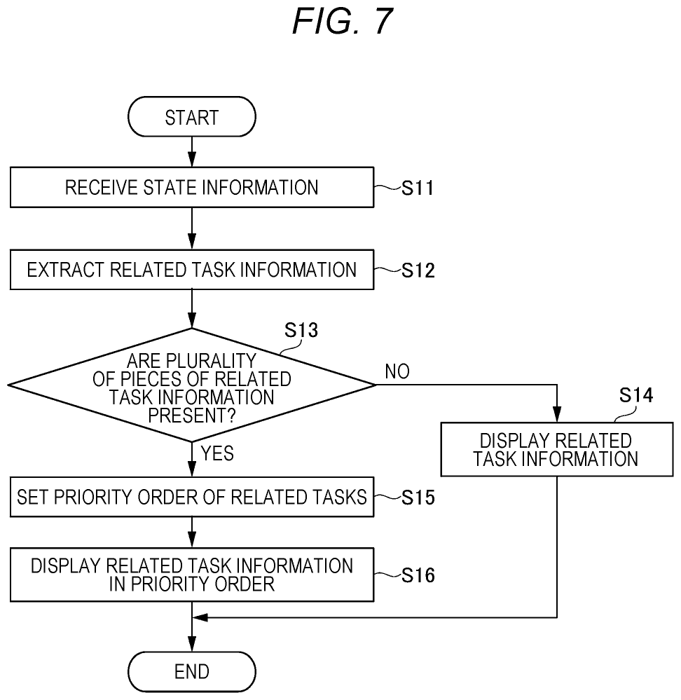

In addition, the monitoring program 31 on the server 30 receives (acquires) the state information regarding the state of the printing machine 10 from the management terminal 20. The monitoring program 31 also extracts related task information associated with the acquired state information from the related task information registered in the server 30 in advance and corresponding to the state information. Furthermore, in a case where a plurality of pieces of the extracted related task information are present, the monitoring program 31 calculates the priority order in which the pieces of related task information are to be displayed. Furthermore, the monitoring program 31 outputs at least one of the plurality of pieces of related task information based on the calculated priority order. The monitoring program 31 will be described in detail below with reference to FIG. 7. A result of executing the monitoring program 31, for example, the related task information arranged in the priority order or the like is transmitted to the management terminal 20 or the monitoring apparatus 40 and displayed.

The server 30 is not limited to a cloud server, but may be a dedicated server. Further, functions of the server 30 may be provided in an information processing apparatus such as the management terminal 20 or the monitoring apparatus 40.

The monitoring apparatus 40 is a display terminal that is connected to the server 30 via the network and receives the related task information arranged in the priority order or the like from the server 30 and displays the related task information arranged in the priority order or the like. When displaying the pieces of related task information, the monitoring apparatus 40 displays at least one of the plurality of pieces of related task information in the priority order according to, for example, the size of a display screen of the monitoring apparatus 40, a number designated by the operator, or the like. The monitoring apparatus 40 may be an information processing apparatus that has the functions of the server 30 and executes the monitoring program 31 instead of the server 30. In addition, the monitoring apparatus 40 may transmit the received related task information arranged in the priority order and the like to a terminal device possessed by the operator who performs the recovery task, or may transmit the related task information arranged in the priority order and the like to a contact address (e.g., a mail address) of the operator. In this case, as a premise, the contact address of the operator is registered in the monitoring apparatus 40 in advance.

Next, an example of data of an execution history of the related task in the printing system I will be described. The execution history of the related task is registered in the server in advance. The execution history of the related task is updated based on a result indicating whether or not the state (problem) of the printing machine has been cleared, and transmitted after the operator performs the related task corresponding to the state information. An execution history of the related task is provided for each piece of state information. FIG. 2 illustrates an example of the data of the execution history of the related task in the printing system 1 according to the present embodiment. The execution history of the related task is associated with the state information, and has “related task”, “task time (minutes)”, “corresponding number of times”, and “corresponding probability” fields, as illustrated in FIG. 2.

The “related task” field stores an identifier that can uniquely identify the related task and is a name or an identification (ID). For example, in the “related task” field illustrated in FIG. 2, the names of related tasks such as “A”, “B”, and “C” are stored.

The “task time (minutes)” field stores a task time relating to the related task stored in the corresponding “related task” field in units of minutes, for example. The task time relating to the related task is an actual task time when the operator has performed the related task or an estimated task time required for performing the related task. The estimated task time is a task time estimated in advance based on the content of the related task. For example, task times such as “5” (minutes) and “30” (minutes) are stored in the “task time (minutes)” field illustrated in FIG. 2.

The “corresponding number of times” field stores the number of times that the state (problem) of the printing machine has been cleared by performing the related task stored in the corresponding “related task” field. For example, “200”, “300”, “500”, and the like are stored in the “corresponding number of times” field illustrated in FIG. 2.

In the “corresponding probability” field, corresponding probabilities of the related tasks calculated based on the data stored in the corresponding “corresponding number of times” field, such as “0.2”, “0.3”, and “0.5” illustrated in FIG. 2, are stored. Each of the corresponding probabilities is a ratio of the corresponding number of times of the related task to a total value of the corresponding numbers of times of the plurality of related tasks stored in execution histories of the related tasks. For example, the ratio of the corresponding number “200” of times of the related task “A” to the total value (“200”+ “300”+“500”=1000) of the corresponding numbers of times of the plurality of related tasks is “0.2”. The unit of each “corresponding probability” may be a percentage.

Although the execution history of each related task illustrated in FIG. 2 includes the “corresponding number of times” and the “corresponding probability” of the related task, the present invention is not limited thereto. A configuration may be adopted in which the execution history of the related task includes one of the “corresponding number of times” and the “corresponding probability”.

Next, a first calculation method of calculating the priority order of related tasks in the printing system 1 will be described.

The first calculation method of calculating the priority order of the related tasks is performed by the monitoring program 31 on the server 30, and calculates the priority order of the related tasks based on at least one of the corresponding number of times of each of the related tasks and the actual task time or the estimated task time required for performing each of the related tasks. When the priority order is calculated based on only the corresponding numbers of times, the first calculation method determines, as the priority order, the descending order (order from the highest to the lowest) of corresponding probabilities calculated using the corresponding numbers of times of the related tasks. In addition, in a case where the priority order is calculated based on only the actual task times or the estimated task times, the first calculation method determines, as the priority order, the ascending order (order from the shortest to the longest) of the actual task times or the estimated task times required for performing the related tasks.

When the priority order is calculated based on the corresponding numbers of times and the actual task times or the estimated task times, the first calculation method determines the priority order based on the products of the reciprocals of the corresponding probabilities calculated using the corresponding numbers of times of the related tasks and the actual task times or the estimated task times required for performing the related tasks. As a specific example of this case, an example will be described in which priorities are calculated for the related tasks “A”, “B”, and “C” based on the execution histories of the related tasks illustrated in FIG. 2. The first calculation method calculates, as a priority index, the product of the reciprocal of the “corresponding probability” and the “task time (minutes)” of the execution history of the related task. For example, the priority index of the related task “A” illustrated in FIG. 2 is 5×(1/0.2)=25, and the priority indices of the related tasks “B” and “C” are “60” and “100”, respectively. The first calculation method determines, as the priority order, the ascending order (order from the smallest to the largest) of the calculated priority indices. With such a calculation method, it is possible to output and display a plurality of pieces of related task information in the order from the shortest task time and from the highest probability that the state (problem) of the printing machine can be cleared, that is, in the most efficient order.

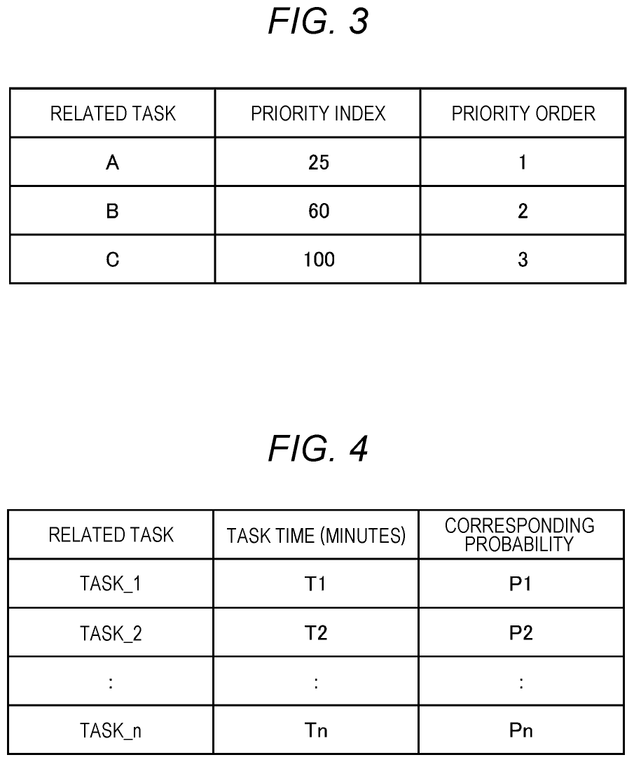

FIG. 3 illustrates the priority order of the related tasks calculated by the first calculation method in the printing system 1 according to the present embodiment. FIG. 3 illustrates the “priority index” and the “priority” of each of the related tasks “A”, “B”, and “C”. As illustrated in FIG. 3, the priority index “25” of the related task “A” is the smallest, and thus “1” which is the highest “priority” is assigned to the related task “A”. Further, as illustrated in FIG. 3, the priority index “100” of the related task “C” is the largest, and thus “3” which is the lowest “priority” is assigned to the related task “C”.

Further, in a case where a plurality of pieces of related task information associated with the state information are present and a certain related task cannot clear the state (problem) of the printing machine in a recovery task, other related tasks are generally tried one by one until the problem can be solved. In this case, due to a difference in the order of the related tasks, a task time to be elapsed until a related task that can solve the problem is found varies. Therefore, it is difficult to select the execution order of the related tasks in which the task time is short and the corresponding probability is high. A second calculation method of calculating the priority order of related tasks in the printing system I has been devised in consideration of the above-described situation. The second calculation method of calculating the priority order of the related tasks is performed by the monitoring program 31 on the server 30, similarly to the first calculation method. The second calculation method calculates an expected value of a task time corresponding to an order pattern based on the corresponding probabilities of the plurality of related tasks and the actual task times or the estimated task times for the order pattern that can be obtained in a case where the plurality of related tasks are performed in order. The second calculation method determines the priority order based on the calculated expected value of the task time.

FIG. 4 is a diagram for explaining the second calculation method of calculating the priority order of related tasks in the printing system 1 according to the present embodiment. FIG. 4 illustrates execution histories of related tasks associated with certain state information. The execution histories of the related tasks illustrated in FIG. 4 do not include the “corresponding numbers of times” described in FIG. 2. “Related task”, “task time (minutes)”, and “corresponding probability” fields illustrated in FIG. 4 are the same as the fields illustrated in FIG. 2, and redundant description is omitted. Furthermore, in FIG. 4, “task_1” to “task_n” are present as the plurality of related tasks associated with the certain state information. “Task times (minutes)” corresponding to the tasks “task_1” to “task_n” are “T1” to “Tn”, and “corresponding probabilities” corresponding to the tasks “task_1” to “task_n” are “P1” to “Pn”.

The second calculation method of calculating the priority order of the related tasks calculates, using the following Equations (1) to (4), expected values of the task times required for performing, in order, “task_1” to “task_n” indicated in the execution histories of the related tasks. The second calculation method determines the ascending order (order from the smallest value to the largest value) of the calculated expected values of the task times as the priority order. “T1” to “Tn” and “P1” to “Pn” in Equations (1) to (4) are the “task times (minutes)” and the “corresponding probabilities” illustrated in FIG. 4.

$$TP 1 = T 1 \times P 1 \qquad ( 1 )$$

Equation (1) is an equation for calculating “TP1” that is the expected value of the individual task time corresponding to “task_1”.

$$TP 2 = T 1 \times P 1 + ( T 1 + T 2 ) \times P 2 \qquad ( 2 )$$

In Equation (2), (T1+T2)×P2 is the expected value of the individual task time corresponding to “task_2”. The expected value “TP2” of the task time when the related tasks are performed in the order from “task_1” to “task_2” is a total value of the expected values of the individual task times required for performing “task_1” and “task_2”.

$$TP 3 = T 1 \times P 1 + ( T 1 + T 2 ) \times P 2 + ( T 1 + T 2 + T 3 ) \times P 3 \qquad ( 3 )$$

In Equation (3), (T1+T2+T3)× P3 is the expected value of the individual task time corresponding to “task_3”. The expected value “TP3” of the task time when the related tasks are performed in the order from “task_1” to “task_3” is a total value of the expected values of the individual task times required for performing “task_1”, “task_2”, and “task 3”.

$$TPn = T 1 \times P 1 + ( T 1 + T 2 ) \times P 2 + ( T 1 + T 2 + T 3 ) \times P 3 + … + ( T 1 + … + Tn ) \times Pn \qquad ( 4 )$$

In Equation (4), (T1+ . . . +Tn)×Pn is the expected value of the individual task time corresponding to “task_n”. The expected value “TPn” of the task time required for performing the related tasks in the order from “task_1” to “task_n” is a total value of the expected values of the individual task times required for performing “task_1” to “task_n”.

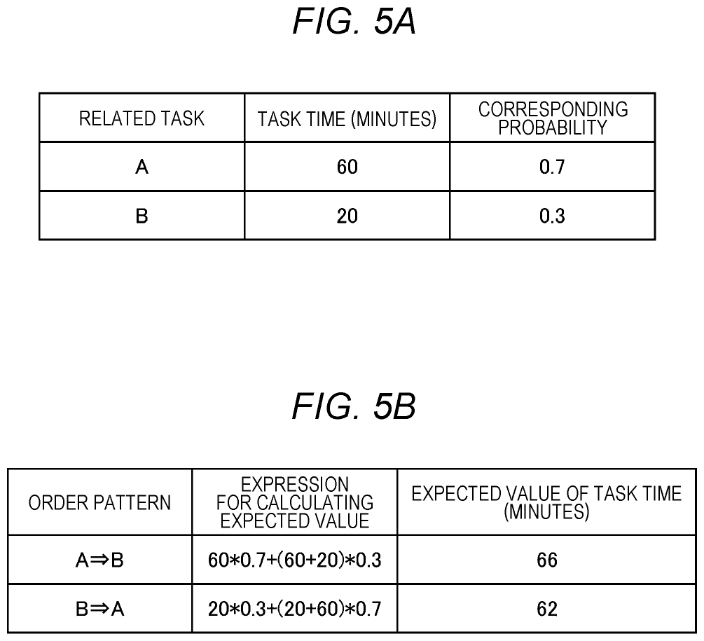

FIGS. 5A and 5B are diagrams for explaining a first specific example of the second calculation method of calculating the priority order of related tasks. FIG. 5A is a diagram illustrating execution histories of related tasks associated with certain state information. FIG. 5B is a diagram illustrating expected values of task times calculated by the second calculation method based on the execution histories of the related tasks illustrated in FIG. 5A. Each of the execution histories of the related tasks illustrated in FIG. 5A has the same configuration as that of each of the execution histories of the related tasks illustrated in FIG. 4, and redundant description will be omitted.

Since two related tasks “A” and “B” are present in the execution histories of the related tasks illustrated in FIG. 5A, two order patterns that can be obtained in a case where the related tasks are performed in order are present, which are an order pattern from the related task “A” to the related task “B” and an order pattern from the related task “B” to the related task “A”, as illustrated in FIG. 5B.

In the order pattern from the related task “A” to the related task “B”, the “task time (minutes)” and the “corresponding probability” of the related task “A” are “T1” and “P1” in Equation (2), and the “task time (minutes)” and the “corresponding probability” of the related task “B” are “T2” and “P2” in Equation (2). Therefore, the expected value of the task time in this order pattern is 60×0.7+ (60+20)×0.3=66 (minutes) according to Equation (2).

Furthermore, in the order pattern from the related task “B” to the related task “A”, the “task time (minutes)” and the “corresponding probability” of the related task “B” are “T1” and “P1” in Equation (2), and the “task time (minutes)” and the “corresponding probability” of the related task “A” are “T2” and “P2” in Equation (2). Therefore, the expected value of the task time in this order pattern is 20×0.3+ (20+60)×0.7=62 (minutes) according to Equation (2).

As illustrated in FIG. 5B, the expected value of the task time in the order pattern from the related task “B” to the related task “A” is smaller than the expected value of the task time in the order pattern from the related task “A” to the related task “B”. Therefore, the second calculation method assigns a high priority to the order pattern from the related task “B” to the related task “A”.

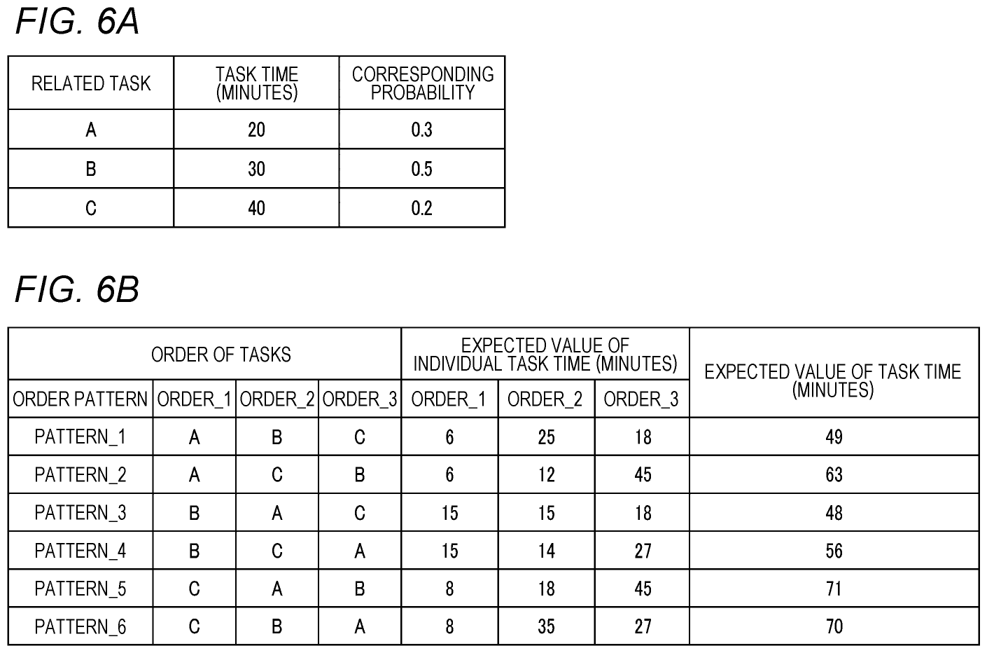

FIGS. 6A and 6B are diagrams for explaining a second specific example of the second calculation method of calculating the priority order of related tasks. FIG. 6A is a diagram illustrating execution histories of related tasks associated with certain state information. FIG. 6B is a diagram illustrating expected values of task times calculated by the second calculation method based on the execution histories of the related tasks illustrated in FIG. 6A. Each of the execution histories of the related tasks illustrated in FIG. 6A has the same configuration as that of each of the execution histories of the related tasks illustrated in FIG. 4, and redundant description will be omitted.

Since three related tasks “A,” “B,” and “C” are present in the execution histories of the related tasks illustrated in FIG. 6A, six order patterns (“pattern_1” to “pattern_6”) that can be obtained in a case where the related tasks are performed in order are present, as illustrated in FIG. 6B. In each of the six order patterns, the related tasks stored in “order_1” to “order_3” illustrated in FIG. 6B are performed in order. For example, in “pattern_1”, the related tasks “A”, “B”, and “C” are performed in order in accordance with “order_1” to “order_3”. Further, for example, in “pattern_5”, the related tasks “C”, “A”, and “B” are performed in order in accordance with “order_1” to “order_3”.

In addition, FIG. 6B illustrates an “expected value (minutes) of an individual task time” in each of “order_1” to “order_3” in each of the order patterns. The “expected value (minutes) of the individual task time” in “order_1” is a result of calculating T1×P1 in Equation (3). The “expected value (minutes) of the individual task time” in “order_2” is a result of calculating (T1+T2)× P2 in Equation (3). The “expected value (minutes) of the individual task time” in “order_3” is a result of calculating (T1+T2+T3)× P3 in Equation (3). The “expected value (minutes) of the task time” in each of the order patterns is a total value of the “expected values (minutes) of the individual task times” in “order_1” to “order_3”.

The calculation of the “expected value (minutes) of the task time” in “pattern_5” will be described below as a specific example of the second calculation method. In “pattern_5”, the related tasks “C”, “A”, and “B” are performed in order in accordance with “order_1” to “order_3”, and thus the “task time (minutes)” and the “corresponding probability” of the related task “C” illustrated in FIG. 6A are “T1” and “P1” in Equation (3). Furthermore, the “task time (minutes)” and the “corresponding probability” of the related task “A” illustrated in FIG. 6A are “T2” and “P2” in Equation (3), and the “task time (minutes)” and the “corresponding probability” of the related task “B” are “T3” and “P3” in Equation (3). Therefore, the “expected value of the individual task time (minutes)” in “order_1” (related task “C”) in “pattern_5” is 40× 0.2=8. The “expected value (minutes) of the individual task time” in “order_2” (related task “A”) is (40+20)×0.3=18. The “expected value (minutes) of the individual task time” in “order_3” (related task “B”) is (40+20+30)×0.5=45. The “expected value of task time (minutes)” of the “pattern_5” is 8+18+45=71.

The second calculation method determines, as the priority order, the ascending order (order from the smallest to the largest) of the “expected values (minutes) of the task times” illustrated in FIG. 6B, that is, the order of “pattern_3”, “pattern_1”, “pattern_4”, “pattern_2”, “pattern_6”, and “pattern_5”.

As described above, the second calculation method calculates the expected value of the task time in each order pattern that can be obtained in a case where the plurality of related tasks are performed in order, based on the corresponding probabilities of the plurality of related tasks and the actual task times or the estimated task times. Therefore, the second calculation method can output and display the related task information in the order from the smallest expected value of the task time to the largest expected value of the task time, that is, in the most efficient order.

### [Procedure of Monitoring Process]

Next, a procedure of a monitoring process in the printing system I will be described. FIG. 7 is a flowchart illustrating the procedure of the monitoring process in the printing system 1 according to the present embodiment. The process described below starts when the management terminal 20 transmits state information regarding the state of the printing machine 10 to the server 30.

First, the server 30 (monitoring program 31) receives the state information regarding the state of the printing machine 10 from the management terminal 20 (step S11).

Next, the server 30 extracts related task information associated with the received state information from the related task information corresponding to the state information registered in advance in the server 30 (step S12).

Next, the server 30 determines whether or not a plurality of pieces of the extracted related task information are present (step S13).

In a case where the server 30 determines that the number of pieces of the extracted related task information is not plural in the processing in step S13 (No in step S13), the server 30 transmits the extracted related task information to the monitoring apparatus 40, and the monitoring apparatus 40 displays the received related task information (step S14).

On the other hand, in a case where the server 30 determines that the plurality of pieces of extracted related task information are present in the processing in step S13 (Yes in step S13), the server 30 calculates and sets the priority order of a plurality of related tasks indicated by the extracted pieces of related task information (step S15). The priority order is calculated by the first calculation method described with reference to FIGS. 2 and 3 or the second calculation method described with reference to FIGS. 4 to 6.

Next, the server 30 transmits the related task information arranged in the priority order to the monitoring apparatus 40, and the monitoring apparatus 40 displays the related task information in the priority order (step S16). In this processing, for example, the monitoring apparatus 40 displays the plurality of pieces of extracted related task information in a list, and displays the related task information in the priority order from the top of the list.

After the processing in step S14 or step S16, the monitoring process ends.

The work efficiency can be improved by the operator performing the recovery task clicking on the related task information in order from the top (from the most efficient task) of the list of the related task information displayed on the monitoring apparatus 40 and performing the related task while viewing a moving image of the related task, a procedure manual of the related task, or the like. In addition, after performing the related task, the operator inputs, to the monitoring apparatus 40, an execution result of the related task, for example, a result indicating that the state of the printing machine has been cleared or a result indicating that the state of the printing machine has not been cleared, the task time taken for performing the related task, and the like, and the monitoring apparatus 40 transmits the execution result of the related task to the server 30. The server 30 updates the execution history of the related task (see FIG. 2) based on the execution result of the related task received from the monitoring apparatus 40. For example, in a case where the execution result of the related task is a result indicating that the state of the printing machine has been cleared, the server 30 adds “1” to the “corresponding number of times” of the related task, and also updates the “corresponding probability” of the related task.

Furthermore, for example, when the execution result of the related task input by the operator is a result indicating that the state of the printing machine could not be cleared, the monitoring apparatus 40 deletes the related task information of the related task from the list, and sequentially prompts the operator to view other related task information or automatically displays the other related task information until a result indicating that the state of the printing machine has been cleared is input.

### [Hardware Configuration of Monitoring Apparatus]

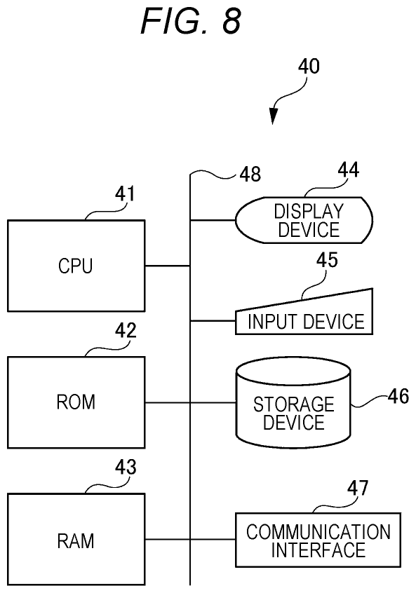

Next, an example of a hardware configuration of the monitoring apparatus 40 will be described. FIG. 8 is a block diagram illustrating an example of the hardware configuration of the monitoring apparatus 40 of the printing system 1 according to the present embodiment.

The monitoring apparatus 40 is an example of an information processing apparatus and includes a central processing unit (CPU) 41, a read only memory (ROM) 42, and a random access memory (RAM) 43 as illustrated in FIG. 8. The monitoring apparatus 40 further includes a display device 44, an input device 45, a storage device 46, and a communication interface 47.

The CPU 41, the ROM 42, the RAM 43, the display device 44, the input device 45, the storage device 46, and the communication interface 47 are connected to each other via a bus 48 so as to be able to transmit and receive information and data to and from each other.

The CPU 41 reads, from the ROM 42, a software program that implements each function of the monitoring apparatus 40, loads the program into the RAM 43, and executes the program. For example, in a case where the monitoring apparatus 40 has the functions of the server 30 and performs the monitoring process illustrated in FIG. 7 instead of the server 30, the CPU 41 executes the monitoring program 31 for performing the monitoring process. A graphics processing unit (GPU) may be used instead of the CPU 41, or the CPU 41 and a graphics processing unit (GPU) may be used in combination.

The ROM 42 includes, for example, a storage medium such as a nonvolatile memory and stores programs, data and the like that are executed and referenced by the CPU 41.

The RAM43 includes, for example, a storage medium such as a volatile memory and temporarily stores information (data) necessary for each process to be performed by the CPU 41.

The display device 44 is, for example, a liquid crystal display (LCD), an organic electro-luminescence (EL) display, or the like, and displays a result of processing performed by the monitoring apparatus 40 and the like. Furthermore, the display device 44 displays related task information received from the server 30 in the priority order of related tasks. The input device 45 includes, for example, a keyboard, a mouse, and the like.

The input device 45 generates an operation signal indicating input details of an operation and supplies the operation signal to the CPU 41. The display device 44 displays the details of the operation, setting information, and the like based on a display signal supplied from the CPU 41. The display device 44 and the input device 45 may be integrally formed as, for example, a touch screen.

The storage device 46 includes a non-transitory recording medium storing a computer-readable program, that is, for example, a hard disk drive (HDD) or the like. The storage device 46 stores the computer-readable program to be executed by the CPU 41, an operating system (OS), a program of a controller, and the like. In addition, in a case where the monitoring apparatus 40 has the functions of the server 30 and performs the monitoring process illustrated in FIG. 7 instead of the server 30, the storage device 46 stores the related task information registered in advance and corresponding to the state information of the printing machine 10.

Some of the programs and data stored in the storage device 46 may be stored in the ROM 42. Furthermore, the non-transitory recording medium storing the computer-readable program to be executed by the CPU 41 is not limited to the HDD but may be, for example, a recording medium such as a solid state drive (SSD), a compact disc (CD-ROM), or a digital versatile disc (DVD-ROM).

The communication interface 47 includes a network interface card (NIC) or the like, for example. The communication interface 47 can transmit and receive various types of data to and from an external server via a local area network (LAN), a dedicated line, or the like connected to a terminal of the NIC.

### [Effects]

As described above, when extracting a plurality of pieces of related task information associated with state information regarding the state of the printing machine, the server 30 (the monitoring program 31) of the printing system 1 according to the present embodiment calculates the priority order in which the pieces of related task information are to be output (displayed). The monitoring program 31 assigns a high priority to related task information indicating a short task time and a high corresponding probability based on the task time (actual task time or estimated task time) and the corresponding probability of each related task, and outputs the related task information. Therefore, the printing system according to the present embodiment can present information regarding a related task for handling a problem of the printing machine in the most efficient order, and can improve the work efficiency in handling the problem.

### Second Embodiment

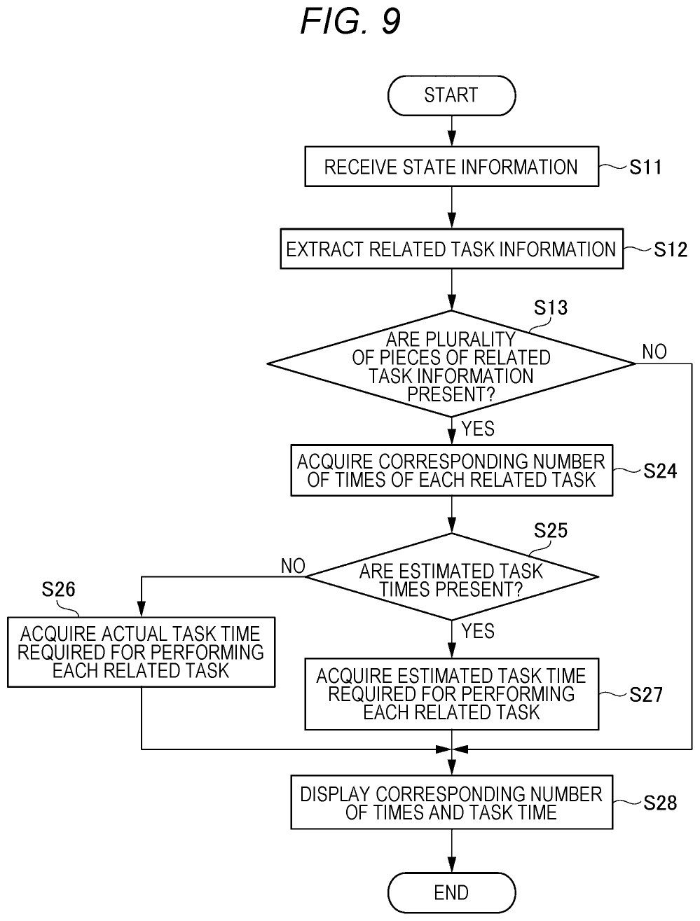

A printing system according to a second embodiment of the present invention will be described below. Since the printing system according to the second embodiment has the same configuration as that of the printing system 1 illustrated in FIG. 1, a redundant description will be omitted. In the present embodiment, it is assumed that, in a “task time (minutes)” included in an execution history (see FIG. 2) of a related task registered in advance, an actual task time and an estimated task time are stored in a distinguished manner. FIG. 9 is a flowchart illustrating a procedure of a monitoring process in the printing system according to the second embodiment of the present invention. As can be seen from a comparison between FIG. 9 and FIG. 7, processing from step S11 to step S13 of the monitoring process in the printing system according to the present embodiment is the same as the processing illustrated in FIG. 7, and therefore redundant description will be omitted.

In the processing in step S13, in a case where the server 30 determines that the number of pieces of extracted related task information is not plural (No in step S13), the server 30 performs processing in step S28 which will be described later.

On the other hand, in the processing in step S13, in a case where the server 30 determines that a plurality of pieces of extracted related task information are present (Yes in Step S13), the server 30 acquires a corresponding number of times of each of the plurality of pieces of extracted related task information from execution histories of related tasks (step S24).

Next, the server 30 determines whether or not estimated task times required for performing the related tasks indicated by the extracted related task information are present in the execution histories of the related tasks (step S25).

In the processing in step S25, in a case where the server 30 determines that the estimated task times required for performing the related tasks indicated by the extracted related task information are not present (No in step S25), the server 30 acquires actual task times required for performing the related tasks indicated by the extracted related task information from the execution histories of the related tasks (step S26).

On the other hand, in the processing in step S25, in a case where the server 30 determines that the estimated task times required for performing the related tasks indicated by the extracted related task information are present (Yes in step S25), the server 30 acquires the estimated task times required for performing the related tasks indicated by the extracted related task information (step S27). The processing from step S25 to step S27 is repeatedly executed the same number of times as the number of related tasks indicated by the extracted related task information. In addition, in this step, the reason why the estimated task times required for performing the related tasks are preferentially acquired is that, even in a case where the same task is performed by different operators, the actual task time varies, and thus the priority order calculated based on the estimated task times is not affected by the variation in the actual task time due to the difference between the individuals.

After the processing in step S26 or step 27, the server 30 transmits, to the monitoring apparatus 40, the corresponding numbers of times and the task times (the estimated task times or the actual task times) of the related tasks indicated by the extracted related task information, and the monitoring apparatus 40 displays the received corresponding numbers of times of the related tasks and the received task times required for performing the related tasks (step S28). After the processing in step 28, the monitoring process ends.

### [Effects]

As described above, in a case where the server 30 (the monitoring program 31) of the printing system according to the present embodiment extracts the plurality of pieces of related task information associated with the state information regarding the state of the printing machine, the server 30 outputs at least one of the corresponding number of times of each related task and the estimated task time or the actual task time and transmits the output information to the monitoring apparatus 40. The monitoring apparatus 40 also displays the received corresponding number of times of each related task and the estimated task time or the actual task time. The operator can determine the priority order of the related tasks that can improve his/her own work efficiency, based on the corresponding number of times of each related task displayed on the monitoring apparatus 40 and the estimated task time or the actual task time displayed on the monitoring apparatus 40. Therefore, according to the reference information (the corresponding numbers of times and the task times) for determining the priority order presented by the printing system according to the present embodiment, each operator can determine the priority order of the related tasks that can improve his/her work efficiency according to a case where there are a plurality of operators handling a problem of the printing machine, a case where the operator changes to another operator, or the like.

The present invention is not limited to the above-described embodiments, and of course, various other application examples and modification examples can be adopted without departing from the spirit and scope of the present invention described in the claims.

For example, in each of the above-described embodiments, the configuration of the printing system has been described in detail and specifically in order to describe the present invention in an easy-to-understand manner, and the printing system is not necessarily limited to a printing system including all the described configurations. Furthermore, a part of the configuration according to each of the embodiments described here can be replaced with a configuration according to the other embodiment, and furthermore, a configuration according to a certain embodiment can be added to the configuration according to the other embodiment. Furthermore, regarding a part of the configuration of each embodiment, another configuration can be added, deleted, or replaced.

In addition, control lines and information lines that are considered to be necessary for description are illustrated, and all of control lines and information lines on a product are not necessarily illustrated. Actually, it may be considered that almost all of the components are connected to each other.

Although the process in which the server 30 extracts the related task information associated with the state information of the one printing machine 10 included in the printing system 1 has been described in each of the above embodiments, the present invention is not limited thereto. For example, in a case where the printing system 1 includes a plurality of printing machines or in a case where another printing machine connected to the server 30 via a network is present, the server 30 (the monitoring program 31) may extract related task information associated with state information of a printing machine of the same model among the plurality of printing machines. Further, for example, the server 30 may extract related task information associated with state information of a printing machine of the same model and the same lot among the plurality of printing machines. Further, for example, the server 30 may extract related task information associated with state information of a printing machine that performs printing on the same type of recording medium among the plurality of printing machines. Further, for example, the server 30 may extract related task information associated with state information of a printing machine present in the same region among the plurality of printing machines. As described above, in a case where related task information associated with state information of a printing machine is extracted, conditions that can cause the state information may be additionally extracted, so that related task information having a higher corresponding probability can be extracted.

Although embodiments of the present invention have been described and illustrated in detail, the disclosed embodiments are made for purposes of illustration and example only and not limitation. The scope of the present invention should be interpreted by terms of the appended claims.

What is claimed is:

1. A non-transitory recording medium storing a computer-readable monitoring program for causing a computer to execute:
acquiring state information regarding a state of a printing machine;
extracting related task information associated with the acquired state information from registered related task information corresponding to the state information; and
calculating, in a case where a plurality of pieces of the extracted related task information are present, a priority order in which the pieces of related task information are to be displayed.

2. The non-transitory recording medium storing the computer-readable monitoring program according to claim 1, wherein, in the calculating the priority order, the priority order is calculated based on at least one of a corresponding number of times that the state of the printing machine has been cleared by performing a related task indicated by the related task information corresponding to the state information, and an actual task time included in a registered execution history of the related task or an estimated task time required for performing the related task.

3. The non-transitory recording medium storing the computer-readable monitoring program according to claim 2, wherein, in the calculating the priority order, in a case where the priority order of the related task is calculated based on the corresponding number of times and the actual task time or the estimated task time, a corresponding probability that is a ratio of the corresponding number of times of the related task to a total value of corresponding numbers of times of a plurality of related tasks indicated by the plurality of pieces of related task information is calculated, and the priority order is determined based on a product of a reciprocal of the corresponding probability and the actual task time or the estimated task time required for performing the related task.

4. The non-transitory recording medium storing the computer-readable monitoring program according to claim 2, wherein, in the calculating the priority order, an expected value of a task time corresponding to an order pattern that can be obtained in a case where a plurality of related tasks indicated by the plurality of pieces of related task information are performed in order is calculated based on the corresponding probabilities of the plurality of related tasks and actual task times or estimated task times required for performing the plurality of pieces of related tasks, and the priority order is determined based on the expected value of the task time.

5. The non-transitory recording medium storing the computer-readable monitoring program according to claim 1, wherein the related task information is information indicating a content of the related task.

6. The non-transitory recording medium storing the computer-readable monitoring program according to claim 5, wherein the related task information is a moving image indicating the content of the related task.

7. The non-transitory recording medium storing the computer-readable monitoring program according to claim 1, wherein the related task information is information of access to a storage destination of a content of the related task.

8. The non-transitory recording medium storing the computer-readable monitoring program according to claim 1, wherein in the calculating the priority order, at least one of the plurality of pieces of related task information is output based on the priority order.

9. The non-transitory recording medium storing the computer-readable monitoring program according to claim 1, wherein, in a case where a plurality of printing machines are present, in the acquiring the related task information, related task information associated with state information of printing machines of a same model among the plurality of printing machines is extracted.

10. The non-transitory recording medium storing the computer-readable monitoring program according to claim 1, wherein in a case where a plurality of printing machines are present, in the acquiring the related task information, related task information associated with state information of printing machines of a same model and a same lot among the plurality of printing machines is extracted.

11. The non-transitory recording medium storing the computer-readable monitoring program according to claim 1, wherein in a case where a plurality of printing machines are present, in the acquiring the related task information, related task information associated with state information of a printing machine that performs printing on a same type of recording medium among the plurality of printing machines is extracted.

12. The non-transitory recording medium storing the computer-readable monitoring program according to claim 1, wherein in a case where a plurality of printing machines are present, in the acquiring the related task information, related task information associated with state information of printing machines located in a same region among the plurality of printing machines is extracted.

13. A non-transitory recording medium storing a computer-readable monitoring program for causing a computer to execute:
acquiring state information regarding a state of a printing machine;
extracting related task information associated with the acquired state information from registered related task information corresponding to the state information; and
outputting, in a case where a plurality of pieces of the extracted related task information are present, at least one of a corresponding number of times that the state of the printing machine has been cleared by performing a related task indicated by the related task information corresponding to the state information, and an actual task time included in a registered execution history of the related task or an estimated task time required for performing the related task.

14. A printing system comprising:
a printing machine that forms an image on a recording medium; and
a server that acquires state information regarding a state of the printing machine, extracts related task information associated with the acquired state information from registered related task information corresponding to the state information, and calculates, in a case where a plurality of pieces of the extracted related task information are present, a priority order in which the pieces of related task information are to be displayed.

15. The printing system according to claim 14, comprising a display terminal that receives the related task information arranged in the priority order from the server and displays the related task information arranged in the priority order.

16. The printing system according to claim 15, wherein the display terminal displays at least one of the plurality of pieces of related task information in the priority order.
